(19) United States
(12) Patent Application Publication
(10) Pub. No.: US 2004/0103368 A1
(43) Pub. Date: May 27, 2004

(54) Link traverser

(75) Inventors: Yanhong A. Liu, Port Jefferson Station, NY (US); Michael Kifer, Setauket, NY (US)

Correspondence Address: Frank Chau, F. CHAU & ASSOCIATES, LLP, Suite 501, 1900 Hempstead Turnpike, East Meadow, NY, 11554, US

(73) Assignee: Research Foundation of State University of New York

(21) Appl. No.: 10/301,327

(22) Filed: Nov. 21, 2002

(51) Int. Cl. G06F 15/00

(52) U.S. Cl. 715/507

(57) ABSTRACT

A method for searching a link graph comprises generating a script based on a user input, parsing the script into a traversal pattern, traversing a plurality of links of the link graph according to the traversal pattern, extracting from the plurality of links, all documents that match the traversal pattern, and compiling the document into a results document.

### BACKGROUND OF THE INVENTION

1. Field of the Invention

The present invention relates to World Wide Web crawling, and more particularly to a system and method generating a link traverser for querying linked data.

2. Discussion of Prior Art

Existing methods of retrieving information from a set of hyperlinked documents include simple searches and more complex queries.

Commercial browsing tools include, for example, text boxes for accepting URLs and different types of search engines, e.g., search engines for performing keyword searches and search engines that incorporate artificial intelligence features. For each of these tools, a user manually follows many links and can become lost. Further, the act of following links can be tedious and time consuming. Similarly, it can be difficult to compare different documents.

Research in the field of data mining, and in particular Internet searching, has produced many sophisticated methodologies. However, these methods can be associated with steep learning curves, as formulating search conditions using these methods can be a nontrivial task. These methods are typically enhancements of the database query language SQL, and are intended to be used by sophisticated web software developers rather than end users.

Therefore, a need exists for a system and method generating a link traverser for querying linked data.

### SUMMARY OF THE INVENTION

According to an embodiment of the present invention, a method for searching a link graph comprises generating a script based on a user input, parsing the script into a traversal pattern, and traversing a plurality of links of the link graph according to the traversal pattern. The method further comprises extracting from the plurality of links, all documents that match the traversal pattern, and compiling the document into a results document.

A plurality of threads are generated from the script, wherein the threads run in parallel.

The method comprises flagging each visited link, wherein each link is visited once.

The results document is output to one of a file, a browser, and the file and the browser.

The method comprises providing a graphical user interface for the user input.

The user input comprises a starting page of the traversal. The user input comprises at least one traversal step. The user input comprises a search string.

Extracting all documents that match the traversal pattern further comprises searching each link for the search string, and extracting documents from only those links comprising the search string.

According to an embodiment of the present invention, a method for searching a link graph comprises determining, manually, a traversal pattern, traversing the link graph according to the traversal pattern, wherein a plurality of links in the link graph are extracted, appending extracted documents to an output, and displaying the output, wherein the output is displayed prior to a full traversal of the link graph.

The traversal comprises a plurality of parallel threads.

At least one update to the output is made after display the output prior to the full traversal.

According to an embodiment of the present invention, a program storage device is provided, readable by machine, tangibly embodying a program of instructions executable by the machine to perform method steps for searching a link graph. The method comprises generating a script based on a user input, parsing the script into a traversal pattern, and traversing a plurality of links of the link graph according to the traversal pattern. The method further comprises extracting from the plurality of links, all documents that match the traversal pattern, and compiling the document into a results document.

A plurality of threads are generated from the script, wherein the threads run in parallel.

The method further comprises flagging each visited link, wherein each link is visited once.

The results document is output to one of a file, a browser, and the file and the browser.

The method further comprises providing a graphical user interface for the user input. The user input comprises a starting page of the traversal. The user input comprises at least one traversal step. The user input comprises a search string.

Extracting all documents that match the traversal pattern further comprises searching each link for the search string, and extracting documents from only those links comprising the search string.

### BRIEF DESCRIPTION OF THE DRAWINGS

Preferred embodiments of the present invention will be described below in more detail, with reference to the accompanying drawings:

FIG. 1A is a diagram of a link graph;

FIGS. 1C-1E are illustrations of different pages in the link graph of FIG. 1A;

FIG. 2 is a flow chart of a traversal method according to an embodiment of the present invention;

FIG. 3 is a diagram of a graphical user interface according to an embodiment of the present invention;

FIG. 4 is a software architecture according to an embodiment of the present invention; and

FIG. 5 is a system according to an embodiment of the present invention.

### DETAILED DESCRIPTION OF PREFERRED EMBODIMENTS

According to an embodiment of the present invention, a method for using patterns found in and among web pages provides a user with a tool for automatically traversing links and searching for information.

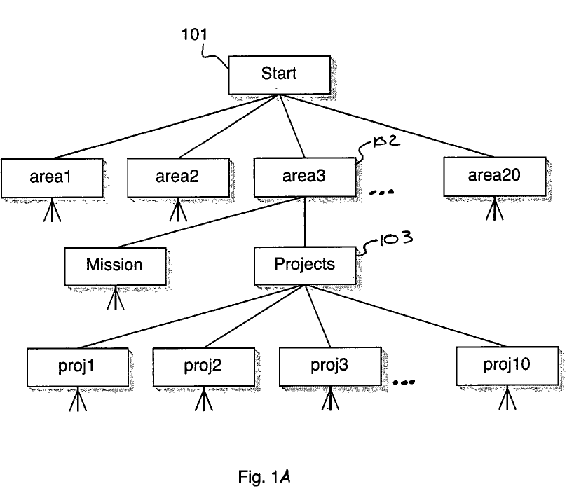

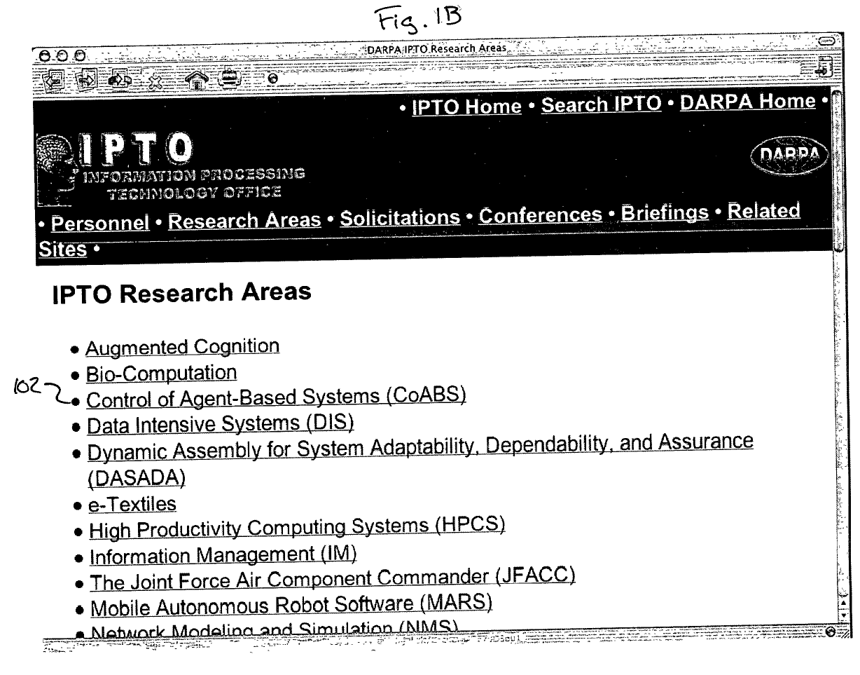

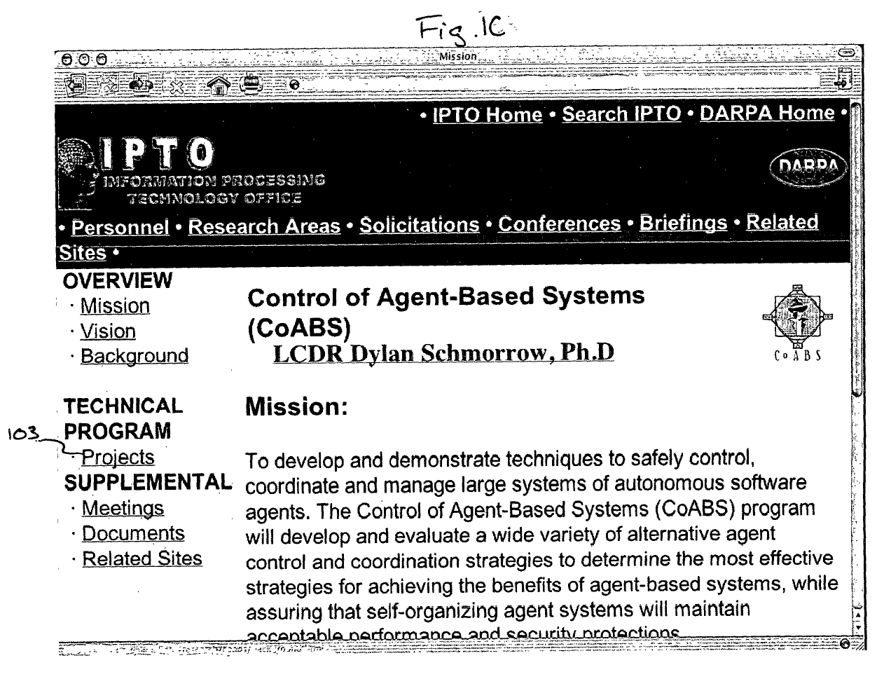

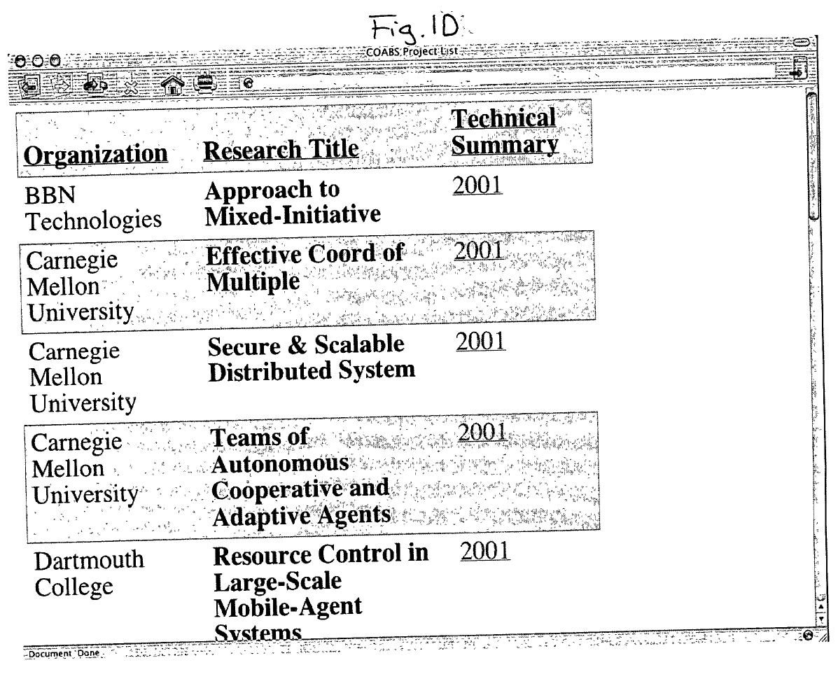

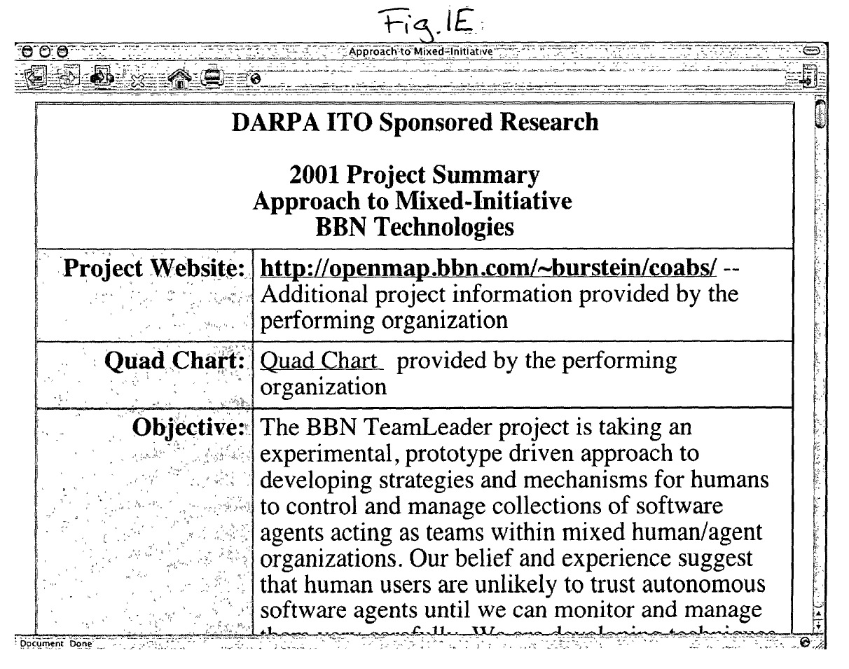

FIG. 1A depicts an example of part of a link graph modeled after the DARPA IPTO (Information Processing Technology Office) research areas web site. The graph structure below each area is similar to that shown below area3 102. Some nodes of the link graph have other links and some links together form cycles.

To browse research projects funded by DARPA IPTO, a user can direct a browser to the main web page of IPTO on Research Areas 101. The main web page or starting page lists links to different research areas, including area3 102. The areas can overlap in many different ways, so for most queries, all of these links need to be explored. FIG. 1B shows an example of the main web page.

For each research area, the user can click on a hyperlinked title to go to a corresponding research area page. Each research area page includes information about the area, and some of the pages include a link called “Projects” 103.

FIG. 1C shows an example of the web page underlying the third hyperlinked research area entitled “Control of Agent-Based Systems (CoABS)”, including the link “Projects” 103. The “Projects” link 103 directs the user to a list of projects, each with institution, title, and a list of hyperlinked years.

FIG. 1D shows the web page underlying “Projects” that includes the list of projects. This page includes one year for each project, while some others include two, three, or more years. Each hyperlinked year directs the user to summary information about the particular project for that year.

FIG. 1E shows the web page underlying the first hyperlinked year “2001”. This page includes project information.

To browse all of the project summary pages manually can involve a large amount of work to repeatedly position the mouse, click it, and wait for response. If the user is to also look for various things on these pages, even with an automatic finder, he or she needs to do so on each page separately.

According to an embodiment of the present invention, a system or method automatically traverses all of the links based on a declarative description of the link structures to be traversed. For the above example, the user can specify the starting web page address, and the links to follow at each level, which are “*”, “Projects”, and “*”, where “*” is a wildcard that matches all links. The link traverser can automatically traverses all the links described above and displays all the web pages in a single browser window.

According to an embodiment of the present invention, a method automatically traverses through links of a network, such as the Internet, following a traversal pattern provided by the user to obtain desired information. The user determines the traversal pattern. The traversal pattern can be described using a convention, for example, comprising a starting point and a set of links. The method collects search results from web pages the match the traversal pattern. The search results can be collated into a document, such as an HTML document, and displayed in a browser such as Netscape®.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

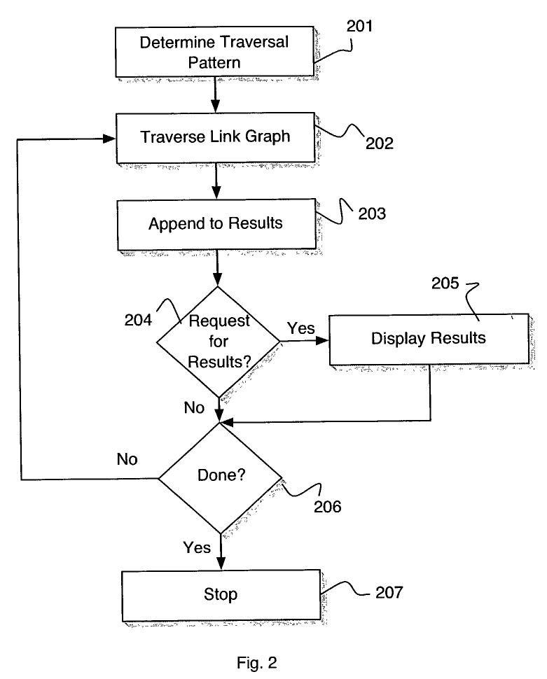

Referring to FIG. 2, upon determining a traversal pattern 201 a method can traverse a link graph 202 for target pages. Upon determining that the target text appears in a given web page, the web page can be appended to a results page 203 generated by the method. If a request for results is made 204, the results can be displayed 205. The results can be displayed prior to the method finishing a traversal of the link graph. The method determines whether additional links exist for traversal 206. Traversal of each new link can be done in a new thread. The method continues to traverse the link graph and append to the results until it determines that there are no more links that match the traversal pattern 207.

To prepare for the search, a user determines a repeatable traversal pattern while he or she performs a manual search on a web site. The traversal pattern can comprise hyperlinks for starting pages, a sequence of links to follow, and a target search string. The user can format the determined traversal pattern as a script using a specified convention. This script can be used to guide the method (e.g., a link traverser) through links and locate the needed pages.

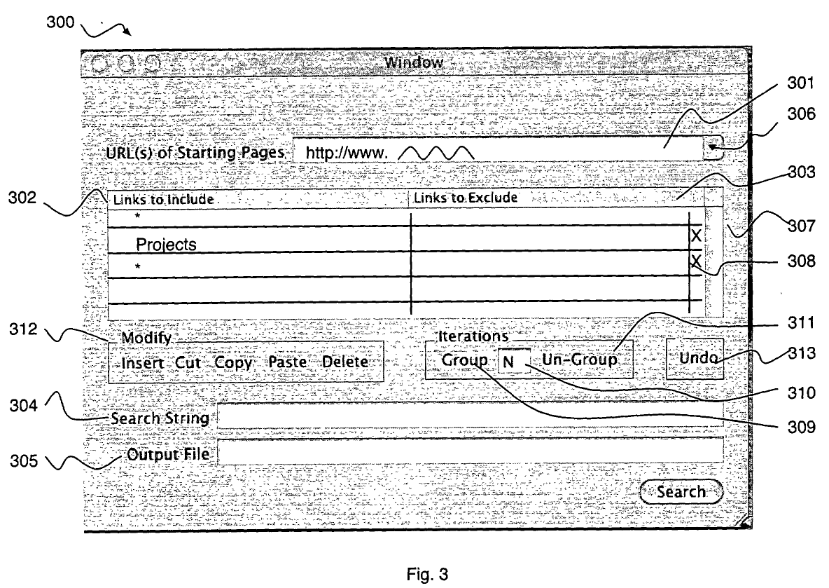

The concepts underlying the script can be explained to an end user. The concepts can be implemented as components in a user-friendly GUI for receiving user input, for example, as described with reference to FIG. 3. Thus, the script can be generated from user input. The script can be based on any structured query language or a language of regular expressions.

The links of interest can be identified using pattern matching. End users can use keywords and/or wildcards for input into the GUI. Additionally, users can use the language of patterns directly. Pattern matching algorithms and implementations can also be used.

The traversal of the links can be multithreaded. Each thread can be used to explore a page. Each thread finds a set of new URLs on a page that matches the next step in the traversal pattern. If an end step in the traversal pattern is reached, the end page can be displayed and/or output. Threads can be exploited incrementally for accessing web pages, e.g., to reduce thread creation and connection time, threads can access multiple pages on the same web server.

The end pages that satisfy a condition, such as containing a target search string of the script, can be displayed and/or output. Further, intermediate pages can be output. Structure and statistics of the links traversed can also be collected and output, for example, showing a tree structure of the pages visited and collected, how many links where taken to reach an end page, or how many end pages where collected. The default for any condition to be satisfied can be set to “true.” Each page output can be preceded or otherwise associated with a URL of the page being output.

The results can be presented incrementally as the results are produced. The results can be displayed automatically in a web browser. The end pages can be appended to the display as they are returned. The content in the browser can scroll up automatically. The results can be written to a file, such as an HTML file stored, for example, on the local machine.

The method can be embodied as a JAVA application or be written in any other suitable programming language. A system according to an embodiment of the present invention reads in a script file prepared by a user and parses it into a traversal pattern. The traversal pattern provides information for the search. The information comprises one or more URLs of the starting web pages, a sequence of links to follow, and a name of the output file. The system opens an input stream from the starting web pages and reads in the HTML document and starts processing the sequence of links to follow. Eventually the system reaches leaf pages. It incrementally writes the pages into an output HTML file and incrementally displays this file in the default web browser.

The traversal pattern can be expressed with various notations and in a number of grammars. An example of a grammar for an abstract syntax is, for example:

traversal_pattern ::= starting_pages traversal_steps

[search_string] [output_file]

starting_pages ::= URL_string*
traversal_steps ::= links_to_include links_to_exclude |

traversal_steps traversal_steps |
traversal_steps “//” [n]

links_to_include ::= regular_expression_string
links_to_exclude ::= regular_expression_string
search_string ::= regular_expression_string
output_file ::= file_name_string

where:

“XY” indicates that X is followed by Y;

“X|Y” indicates X or Y, but not both;

“X*” indicates zero or more occurrence of X, one following another; and

“[X]” indicates that X is optional.

A traversal pattern has a plurality of components. The traversal pattern can include “starting_pages”, for example, a set of URLs. The traversal pattern can include “traversal_steps,” a pair of regular-expression strings or, recursively, some traversal_steps followed by more traversal_steps or, recursively, traversal_steps followed by 11, optionally followed by a positive integer.

Given a current page, a pair of regular expressions, (reg1 reg2), comprise a current traversal step. The current traversal step indicates a set of links that are to be followed to arrive at the next pages. The expression reg1 indicates a set of links to include, and reg2 indicates a set of links to exclude from those selected by reg1. A default for inclusion can be set, for example, to all. Likewise, a default for exclusion can be set, for example, to nothing. An end user can list a set of strings or use wildcards. A string matches a set of links whose text includes that string, and the wildcard * matches any link. A set of strings can indicate the union of the sets of links matched by each of the string.

A sequence of traversal_steps shows how to select links sequentially to arrive at pages at increasingly deeper levels. For example, traversal_steps followed by “//” indicates following zero (0) or more traversal_steps. A traversal_steps followed by “//n,” where n is an integer, means that traversal_steps are applied at most n times.

A search_string is optional. It can be a regular expression, and indicates that the output pages should contain a string that matches the search_string. A default can be selected, such as the wildcard *, which matches all pages. An end user can list a set of strings or use the wildcard *. Each string matches a set of pages that include the string, and a set of strings can indicate the union of the sets of pages matched by each of the string.

The output_file is also optional. It indicates the output file. A user can choose a default file name such as output.html, or choose not to save the search result in a file.

According to an embodiment of the present invention, a Graphic User Interface (GUI) can be provided for receiving user input. Referring to FIG. 3, the GUI 300 can accept URLs as starting pages 301, a set of pairs of links to include 302 and links to exclude 303, a search string 304, and a destination file for output 305. One of ordinary skill in the art would appreciate that various GUIs can be provided for these and other functions.

The GUI 300 can include additional features, such as, a scrollable list of editable lines for the list of URLs, or an icon for a pull-down list of URLs last visited from which a user can select 306. A scrollable list of editable lines 307 can include pairs of links to include and links to exclude, with icons 308 for selecting one or more lines. By selecting a grouping of lines and selecting the Group 309 option, the grouping of lines can be identified as a repeatable loop, for example, to traverse through a given number 310 of section pages of a book chapter, wherein each page is a separate web page. A default of ALL can be set for the given number 310. This is similar to the traversal_steps followed by “II” or “//n”. Any two groups need to be disjoint or one properly included in the other. Any number of consecutive lines can be selected by, for example, highlighting the group using a cursor. Grouped lines can be un-grouped 311. Controls 312 can be provided for additional functions as well, for example, for selecting a line to copy, cut, or delete, paste or insert. Further, an undo last function can be provided 313, among others. Each text box, e.g., an include text box, an exclude text box, and a search string text box, can include a list of strings, or a regular expression.

Pages or nodes can be traversed in parallel. The recovered pages can be collated into a common document. Visited pages can be noted or flagged to avoid visiting the same page multiple times and to avoid infinite loops.

Pseudo-code for the present invention can be written as follows:

Main Thread:

get input script from GUI;

parse script to obtain

URLs=URLs of starting pages

stepRE=a regular expression (RE) for the traversal steps

linkREs=a set of include-exclude linkRE pairs in the traversal steps

searchString=a search string

outFile=a output file name;

transform stepRE to a nondeterministic finite automata (NFA) to obtain

s0=start state of the NFA

next=transition relation of the NFA whose labels are linkRE pairs

F=final sets of NFA;

//initialization
workset = {<u,s0>: u in URLs}, with a lock for the workset;
visited = {}; // the set of URL-state pairs considered already
open browser;
output = open(outFile), with a lock for the output;
//loop until traversal is done
lock workset;
while workset != empty

<u,s> = any element in workset;
workset = workset − {<u,s>};

visited = visited + {<u,s>};

unlock workset;

create a new thread which traverses page u based on state s and transition and possibly updates workset, output, and display based on visited;

lock workset;

end while;
//summary
summary = structures and statistics of links traversed;
display summary to browser;
append summary to outFile;
close(output).
Per-Page Thread: given URL u and state s,

go to page u;
if s in F

if searchString=null or searchString!=null and searchString in page text

lock output;
display page content to browser;
append page content to output;
unlock output;

exit;

while ! end of page

t = text of next link on the page;
u2 = URL of the link;
for each label p in outgoing transitions next(s) and target state s2 such that t
matches p

lock workset;
if <u2,s2> not in workset or visited

workset = workset + {<u2,s2>};

unlock workset;

end for;

end while;

where t matches a label <include-RE, exclude-RE> if t matches include-RE but not exclude-RE using standard string pattern matching. The running time of this algorithm is linear in size of the link graph and linear in size of the traversal pattern.

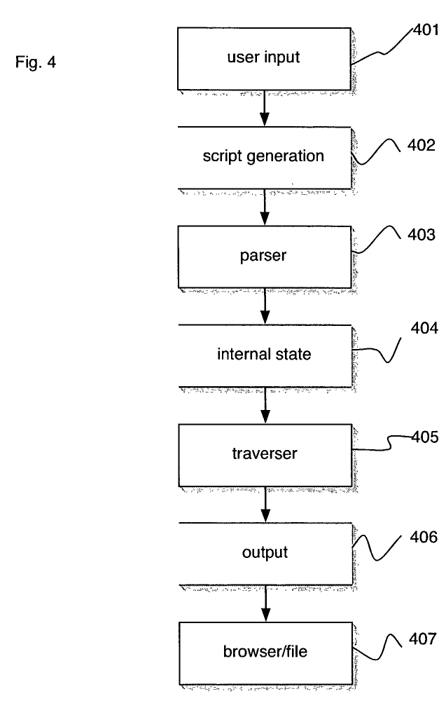

Referring to FIG. 4, in a main thread (shown above) the user input 401 is compiled as a script 402. The script can be parsed to obtain URLs 403, for example, the URL of at least one starting page, a stepRE, that is, a RE for the traversal steps, and a group of links, that is, a set of links to be included and/or excluded. The script can be further parsed to determine linkRE pairs in the traversal steps, a search string, and an output file name, hereinafter, “outFile.”

The stepRE can be transformed to non-deterministic finite automata (NFA) 404. s0 is the start state of the NFA. Variable “next” holds the transition relation of the NFA whose labels are linkRE pairs. F is a final set of NFA.

The software can be initialized as follows, a workset can be defined as {<u,s0>: u in URLs}, with a lock for the workset. The visited links can be defined as { }, the set of URL-state pairs considered to be already open in the browser. The output can be opened by an operation such as open(outFile), with a lock for the file.

A loop can be run until the traversal is done 405. A new thread can be created that traverses each new page u based on state s and transition, and can update workset, output, and display based on visited 406.

A summary of the output can be displayed 407 to a browser and/or appended to an outFile. A summary can include structures and statistics of the links traversed. The main thread can be closed, for example, close(output). The execution time of the method can be linearly related to the size of the link graph and the size of the traversal pattern.

Regular expressions can be used to search a document. Hyper links in an HTML document appear in the same pattern: “<a href=“url-string”>link-text</a>”. Thus, a regular expression can be written for this pattern and the regular expression can be matched with the text in a document, such as an HTML document. Links can then be extracted using the regular expressions. Various utilities for pattern matching are available, for example, as included in Java 1.4.

To traverse the links and search for the needed information, these regular expressions can be applied repeatedly to get a next URL until a leaf page is reached.

Parallel traversals of the links and incremental display of the output can be implemented to reduce system response time.

Consider a search with a single starting page and a depth of three. The searching method gets all the matching links on the starting page, gets all the matching links on each second level page, and gets all the matching links on each third level page.

The system extracts R number of links on the starting page. From each link, the system needs to follow the link and access another page. On each of these R number of pages, S links can be returned yielding a total of R*S links. Each of these R*S links points to a page that contains a list of T matching links. Therefore, to get all the target pages the system needs to access (1+R+R*S+R*S*T) pages. Thus, it can be seen that the numbers of pages searched can be large, for example, on the order of hundreds of pages.

The link traverser can access a large number of web pages in parallel. This can reduce the traversal and response time even on a single processor machine, since much of the response time is due to delay in the networks. The link traverser also displays the output pages in an incremental fashion, so the user can start reading as soon as any matching page is returned.

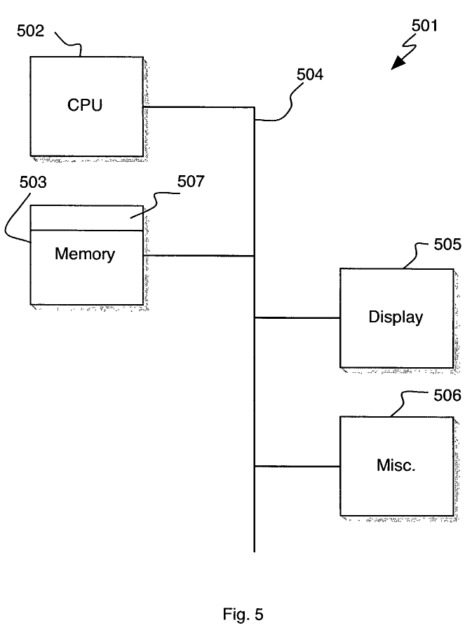

Referring to FIG. 5, a computer system 501 for implementing a link graph search according to an embodiment of the present invention can comprise, inter alia, a central processing unit (CPU) 502, a memory 503 and an input/output (I/O) bus 504. The computer system 501 can be coupled through the I/O bus 504 to a display 505 and various input devices 506 such as a mouse and keyboard. The support circuits can include circuits such as level two (2) cache, power supplies and clock circuits. The memory 503 can include random access memory (RAM), read only memory (ROM), disk drive, tape drive, etc., or a combination thereof. The present invention can be implemented as a script generation and search routine 507 that is stored in memory 503 and executed by the CPU 502. Thus, the computer system 501 can be a general-purpose computer system that becomes a specific purpose computer system when executing the script generation and search routine 507 of the present invention.

One of ordinary skill in the art would recognize, in light of the present invention, that, while a method of traversing links can be applied to for example, a web site, such as that discussed with respect to FIGS. 1A-1E, a method of traversing links can be implemented in conjunction with other structured data. For example, links structured uniformly on webpages presenting items in an Internet store, funded projects of a funding agency, personnel in an organization, or the output of Internet search engines, such as Google™ and AltaVista™. A method of traversing links can be applied to a homepage of an individual that follows a pattern; for example, a university faculty's homepage including a list of hyperlinked publication items, a list of hyperlinked courses, etc. Furthermore, for webpages including non-uniformly structured links, can be traversed for links matching simple patterns; for example, all links.

Having described embodiments for a system and method generating a link traverser for querying linked data, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method for searching a link graph comprising the steps of:
generating a script based on a user input;
parsing the script into a traversal pattern;
traversing a plurality of links of the link graph according to the traversal pattern;
extracting from the plurality of links, all documents that match the traversal pattern; and
compiling the document into a results document.

2. The method of claim 1, wherein a plurality of threads are generated from the script, wherein the threads run in parallel.

3. The method of claim 1, further comprising the step of flagging each visited link, wherein each link is visited once.

4. The method of claim 1, wherein the results document is output to one of a file, a browser, and the file and the browser.

5. The method of claim 1, further comprising the step of providing a graphical user interface for the user input.

6. The method of claim 1, wherein the user input comprises a starting page of the traversal.

7. The method of claim 1, wherein the user input comprises at least one traversal step.

8. The method of claim 1, wherein the user input comprises a search string.

9. The method of claim 1, wherein the step of extracting all documents that match the traversal pattern further comprises searching each link for the search string, and extracting documents from only those links comprising the search string.

10. A method for searching a link graph comprising the steps of:
determining, manually, a traversal pattern;
traversing the link graph according to the traversal pattern, wherein a plurality of links in the link graph are extracted;
appending extracted documents to an output; and
displaying the output, wherein the output is displayed prior to a full traversal of the link graph.

11. The method of claim 10, wherein the traversal comprises a plurality of parallel threads.

12. The method of claim 10, wherein at least one update to the output is made after display the output prior to the full traversal.

13. A program storage device readable by machine, tangibly embodying a program of instructions executable by the machine to perform method steps for searching a link graph, the method steps comprising:
generating a script based on a user input;
parsing the script into a traversal pattern;
traversing a plurality of links of the link graph according to the traversal pattern;
extracting from the plurality of links, all documents that match the traversal pattern; and
compiling the document into a results document.

14. The method of claim 13, wherein a plurality of threads are generated from the script, wherein the threads run in parallel.

15. The method of claim 13, further comprising the step of flagging each visited link, wherein each link is visited once.

16. The method of claim 13, wherein the results document is output to one of a file, a browser, and the file and the browser.

17. The method of claim 13, further comprising the step of providing a graphical user interface for the user input.

18. The method of claim 13, wherein the user input comprises a starting page of the traversal.

19. The method of claim 13, wherein the user input comprises at least one traversal step.

20. The method of claim 13, wherein the user input comprises a search string.

21. The method of claim 13, wherein the step of extracting all documents that match the traversal pattern further comprises searching each link for the search string, and extracting documents from only those links comprising the search string.
